(19) United States
(12) Patent Application Publication
(10) Pub. No.: US 2020/0126123 A1
(43) Pub. Date: Apr. 23, 2020

(54) ADVANCE NOTIFICATION OF CONVENIENT PURCHASE POINTS

(71) Applicant: GOOGLE LLC, Mountain View, CA (US)

(72) Inventor: Benoît Vincent Désiré Loriaux, Christina Lake (CA)

(21) Appl. No.: 16/165,775

(22) Filed: Oct. 19, 2018

(51) Int. Cl. G06Q 30/02; G01C 21/34; G01C 21/36; G01S 19/42; G06Q 50/06

(52) U.S. Cl. CPC G06Q 30/0266; G01C 21/3476; G01C 21/3697; G06Q 50/06; G01S 19/42; G06Q 30/0267; G01C 21/3484

(57) ABSTRACT

In a method for providing advance notification of convenient purchase points includes receiving user data indicative of user locations while the user was driving, and times when the user was driving at those locations. The method also includes determining, by analyzing the user data, a route that the user is likely to drive and a time when the user is likely to begin driving the route, and identifying one or more entities each having a location proximate to the route. Identifying the entities includes analyzing, for each entity, a current price of a good or service provided by the entity and current prices of goods or services provided by one or more other entities. The method also includes providing, at a notification time that is at or prior to the time when the user is likely to begin driving the route, a notification to a mobile device of the user.

### FIELD OF TECHNOLOGY

The present disclosure relates to the provision of point-of-interest information and, more particularly, to providing users with notifications of convenient purchase points along likely driving routes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

For some time now, mapping services and applications have provided a plethora of information to users, above and beyond their core function of providing digital maps and/or navigation instructions. For example, digital maps may be selectively populated with point-of-interest or “POI” information relating to various businesses, or relating to other entities or sites represented on a viewport displayed to a user. When navigation services and applications are used, this allows a user to not only determine a route to a desired destination, but also zoom in and/or pan along the plotted route in order to see POIs that he or she will be passing while driving that route. In this manner, for example, a user might virtually move along an upcoming route to search for gas stations, electric vehicle charging stations or hotels that he or she may come across while driving the route. Such an approach can be very time consuming (particularly for longer routes), however, and in any case may not reveal which POIs would be “best” for the user to visit. If the POIs are associated with providers of goods or services, for example, the POIs may not indicate which provider currently offers the lowest prices, and/or may require that the user spend time doing additional research (e.g., by clicking on website links for the various POIs, and/or calling the entities, etc.).

Alternatively, the user might search for POIs by repeatedly inspecting the map at different points in time as he or she physically moves along the route. Again, however, this approach can be very time consuming, and may not indicate which POIs would be best to visit. Moreover, POI information may not be available at any given time/location along the route, e.g., depending on the quality of cellular service in the area. If the user is driving a vehicle, consulting a map (e.g., on his or her smartphone) may also result in a dangerous level of driver distraction.

More recently, certain online tools (e.g., the Trip Cost Calculator from GasBuddy) have enabled drivers to locate relatively low-priced gas stations along a planned route, while also taking into account variables such as gas mileage and tank size. However, these tools require that the user launch the tool, enter the starting point and destination for a planned trip, and then view the results. This can be a cumbersome process, particularly for routes that the user takes on a fairly frequent basis (e.g., a daily work commute, or a weekly drive to see relatives, etc.).

### SUMMARY

The systems and methods described herein may provide a user, via his or her mobile device (e.g., a smartphone), a notification of one or more entities (e.g., businesses) that is/are currently offering a good or service at a relatively low price point (e.g., a relatively inexpensive gas station, charging station or hotel), and is/are located such that the user may conveniently visit the entity or entities. In particular, the user is notified of one or more such entities that is/are proximate to a route that the user is likely to take, at a time when the information is likely to be useful and convenient for the user (e.g., when the user is almost ready to begin driving the route). In some embodiments, the user need not enter any information indicative of the route (e.g., in a navigation app) in order to receive the notification.

In one example embodiment, a method for providing advance notification of convenient purchase points includes receiving, by one or more processors, user data indicative of (i) a plurality of locations of a user while the user was driving and (ii) times at which the user was driving at the plurality of locations, and determining, by one or more processors analyzing the user data, a route that the user is likely to drive and a time when the user is likely to begin driving the route. The method also includes identifying, by one or more processors, one or more entities each having a location proximate to the route, at least by analyzing, for each of the one or more entities, (i) a current price of a good or service provided by the entity and (ii) current prices of goods or services provided by one or more other entities. The method also includes providing, at a notification time that is at or prior to the time when the user is likely to begin driving the route, a notification to a mobile device of the user, the notification indicating one or both of (i) the one or more entities and (ii) locations of the one or more entities.

In another example embodiment, a computing system includes one or more database memories collectively storing a database, one or more processors, and one or more memories storing instructions. When executed by the one or more processors, the instructions cause the computing system to receive user data indicative of (i) a plurality of locations of a user while the user was driving and (ii) times at which the user was driving at the plurality of locations, and store the received user data in the database. The instructions also cause the computing system to determine, by analyzing the user data stored in the database, a route that the user is likely to drive and a time when the user is likely to begin driving the route. The instructions also cause the computing system to identify one or more entities each having a location proximate to the route, at least in part by analyzing, for each of the one or more entities, (i) a current price of a good or service provided by the entity and (ii) current prices of goods or services provided by one or more other entities. The instructions also cause the computing system to provide, at a notification time that is at or prior to the time when the user is likely to begin driving the route, a notification to a mobile device of the user, the notification indicating one or both of (i) the one or more entities and (ii) locations of the one or more entities.

In another example embodiment, one or more non-transitory, computer-readable media collectively store instructions that, when executed by one or more processors, cause the one or more processors to receive user data indicative of (i) a plurality of locations of a user while the user was driving and (ii) times at which the user was driving at the plurality of locations, and determine, by analyzing the received user data, a route that the user is likely to drive and a time when the user is likely to begin driving the route. The instructions also cause the one or more processors to identify one or more entities each having a location proximate to the route, at least in part by analyzing, for each of the one or more entities, (i) a current price of a good or service provided by the entity and (ii) current prices of goods or services provided by one or more other entities. The instructions also cause the one or more processors to provide, at a notification time that is at or prior to the time when the user is likely to begin driving the route, a notification to a mobile device of the user, the notification indicating one or both of (i) the one or more entities and (ii) locations of the one or more entities.

### BRIEF DESCRIPTION OF THE DRAWINGS

FIG. 1 is a block diagram of an example system in which techniques for providing advance notice of convenient purchase points may be implemented.

FIG. 2 depicts a table of example user data that may be used to determine routes that are likely to be driven by a user, and the timing of such routes.

FIG. 3 depicts an example display screen that presents a notification to a user via a mobile device.

FIG. 4 depicts an example map that may be provided to a user in response to the user entering one or more inputs after receiving the notification.

FIG. 5 is a flow diagram of an example method for providing advance notice of convenient purchase points.

### DETAILED DESCRIPTION OF THE DRAWINGS

### Overview

In some implementations of the invention disclosed herein, mobile device users (e.g., smartphone users, tablet users, etc.) are provided with notifications at or prior to (e.g., 15 minutes before) times when those users are likely to begin driving particular, respective routes, with the notifications each indicating one or more entities (e.g., businesses) and/or entity locations (e.g., business map positions or addresses) that are on or near portions of that route. The notifications may only identify entities that are providers of a good or service (e.g., gas stations, charging stations for electric vehicles, hotels, etc.) that currently offer a price that is low relative to one or more other entities selling the same good or service (e.g., relative to other gas stations, charging stations, hotels, etc., generally, or along the same route, etc.).

To determine a likely route of a given user, and the time the user is likely to drive that route (e.g., day of week and time of day), user data is collected and analyzed, provided that the user first indicates that the system is authorized to collect and use the user data for the purpose of providing notification of convenient purchase points. The user data may be time-stamped GPS data, for example. The user data may be processed to identify the portions of the data that correspond to ground vehicle travel, or a specific type or types of ground vehicle travel (e.g., automobile, motorcycle, etc.), such as by calculating and/or receiving indications of the user's speed. The user data may also be processed to identify a route that the user commonly drives (e.g., at least some threshold number of times per week over the course of 3 months, etc.), as well as a time when the user typically begins driving that route (e.g., every Monday through Friday at about 6:30 am). As the term is used herein, “driving” a route may refer to operating a vehicle along the route, or merely being a passenger while another person (or an autonomous vehicle controller, etc.) operates the vehicle along the route.

To identify the entity or entities along (i.e., on or near) the route, distance thresholding may be applied. For each entity of a particular type (e.g., gas station) that is within a threshold distance of the route, the current price of a good or service provided by that entity may be compared to the current price of that good or service at one or more other entities, or an average of such prices, etc. For each entity that is selling at a relatively low price (e.g., the entities near the route that offer the three lowest prices, etc.), the user may be informed of the entity via a notification. For example, a notification may list the name of each entity offering a low price for the good or service, and/or show a location of the entity. The notification may be provided to a mobile device of the user as a push notification, by a software application supporting an Rich Site Summary (RSS) feed, or in any other suitable manner.

### Example System

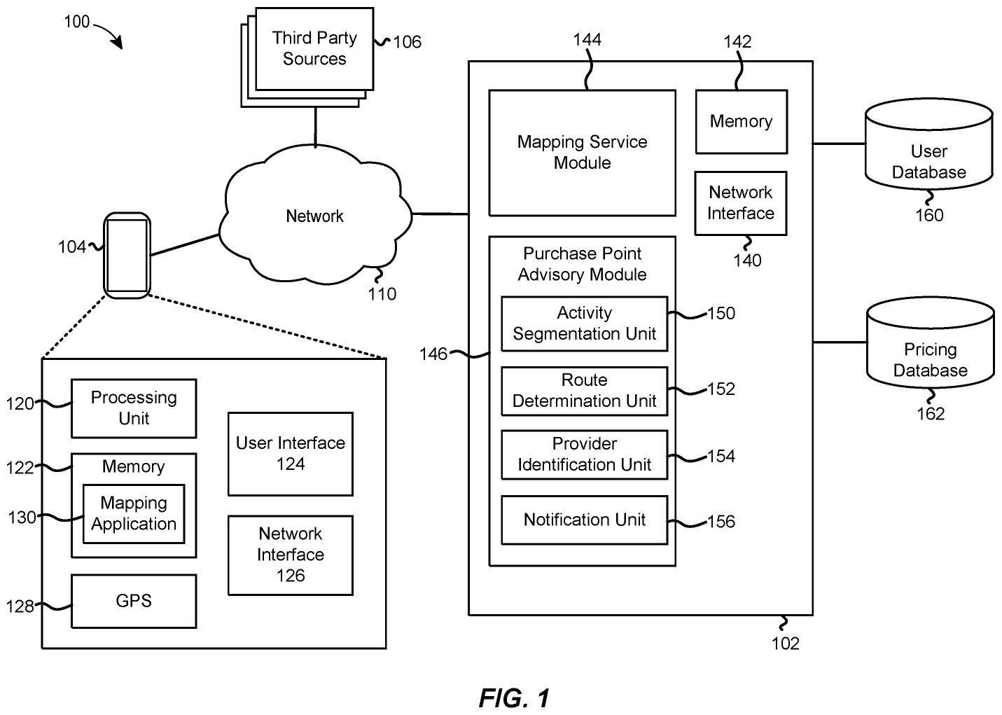

FIG. 1 illustrates an example system 100 in which techniques for providing advance notification of convenient purchase points may be implemented. The system 100 includes a map server 102, a mobile device 104, and one or more third party sources 106. In various different implementations, and as discussed further below, third party sources 106 may include computing devices (e.g., servers) of various businesses, crowdsourcing devices (e.g., smartphones of numerous users), a server that consolidates information from crowdsourcing devices, and/or other suitable sources.

Map server 102 is remote from mobile device 104 and third party sources 106, and communicatively coupled to mobile device 104 and third party sources 106 via a network 110. Network 110 may include any suitable combination of wired and/or wireless communication networks, such as one or more local area networks (LANs), metropolitan area networks (MANs), and/or wide area network (WANs). As just one specific example, network 110 may include a cellular network, the Internet, and a server-side LAN. While referred to herein as a “server,” map server 102 may, in some implementations, include multiple servers and/or other computing devices. Moreover, map server 102 may include multiple servers and/or other computing devices distributed over a large geographic area (e.g., including devices at one or more data centers), and any of the operations, computations, etc., described below may be performed in by remote computing devices in a distributed manner.

Mobile device 104 may be any mobile device with computing and wireless communication capabilities (e.g., a smartphone, tablet computer, laptop computer, smart glasses, vehicle head unit computer, etc.). While FIG. 1 shows only a single mobile device 104, it is understood that map server 102 may also be in communication with numerous other mobile devices similar to mobile device 104, via network 110 and/or other networks. In the example implementation of FIG. 1, mobile device 104 includes a processing unit 120, a memory 122, a user interface 124, a network interface 126, and a global positioning system (GPS) unit 128. Processing unit 120 may be a single processor (e.g., a central processing unit (CPU)), or may include a set of processors (e.g., a CPU and a graphics processing unit (GPU)).

Memory 122 is a computer-readable, non-transitory storage unit or device, or collection of units/devices, that may include persistent (e.g., hard disk) and/or non-persistent memory components. Memory 122 stores instructions that are executable on processing unit 120 to perform various operations, including the instructions of various software applications and data generated and/or used by such applications. In the example implementation of FIG. 1, memory 122 stores at least a mapping application 130. Generally, mapping application 130 is executed by processing unit 120 to access the mapping services provided by map server 102 (e.g., displaying current location to a user, accepting user inputs relating to panning, zooming or entering directions, displaying directions in response to a user navigation request, etc.). While the description below refers to a mapping “application,” it is understood that, in other implementations, other arrangements may be used to access the mapping services provided by map server 102. For example, mobile device 104 may instead access the mapping services via a web browser provided by a web browser application stored in memory 122.

User interface 124 includes hardware, firmware and/or software configured to enable a user to interact with (i.e., both provide inputs to and perceive outputs of) mobile device 104. For example, user interface 124 may include a touchscreen with both display and manual input capabilities. Alternatively, or in addition, user interface 124 may include a keyboard for accepting user inputs, and/or a microphone (with associated processing components) that provides voice control/input capabilities to the user.

Network interface 126 includes hardware, firmware and/or software configured to enable mobile communications device 104 to wirelessly exchange electronic data with map server 102 via network 110. For example, network interface 126 may include a cellular communication transceiver, a WiFi transceiver, and/or transceivers for one or more other wireless communication technologies.

GPS unit 128 includes hardware, firmware and/or software configured to enable mobile device 104 to self-locate using GPS technology (alone, or in combination with the services of map server 102 and/or another server not shown in FIG. 1). Alternatively, or in addition, mobile device 104 may include a unit configured to self-locate, or configured to cooperate with a remote server or other device(s) to self-locate, using other, non-GPS technologies. For example, mobile device 104 may include a unit configured to self-locate using WiFi positioning technology (e.g., by sending signal strengths detected from nearby access points to map server 102, or to another server able to retrieve access point locations from a database).

In some implementations, mapping application 130 (or other software stored in memory 122) provides functionality for communicating with one or more units of a vehicle. If mobile device 104 is itself a unit integrated in the vehicle (e.g., a head unit providing vehicle dashboard integrated navigation technology), for example, the mobile device 104 may have a hardwired connection (e.g., via a Controller Area Network (CAN) bus) to one or more other units of the vehicle. As another example, if mobile device 104 is a smartphone (or smart watch, etc.), mobile device 104 may couple to one or more units of the vehicle via a wired connection (e.g., USB) or a wireless connection (e.g., Bluetooth, WiFi, etc.).

In one example implementation, mobile device 104 communicates with a vehicle unit equipped with a sensor that senses the level of gas in the gas tank (and/or the amount of charge left for an electric vehicle). Additionally or alternatively, mobile device 104 may communicate with a vehicle unit that estimates the fuel efficiency (e.g., miles per gallon) of the vehicle substantially in real-time as the vehicle is driven (e.g., based on speed, acceleration, etc.). The vehicle unit(s) may provide this and/or other vehicle information to mobile device 104 for various purposes, as discussed further below.

Map server 102 includes a network interface 140, a memory 142, a mapping service module 144 and a purchase point advisory (PPA) module 146. The network interface 140 includes hardware, firmware and/or software configured to enable map server 102 to exchange electronic data with mobile device 104 via network 110. For example, network interface 140 may include a wired or wireless router and a modem.

Memory 142 is a computer-readable, non-transitory storage unit or device, or collection of such units/devices, that may include persistent (e.g., hard disk) and/or non-persistent memory components. Memory 142 may store data generated and/or used by mapping service module 144 and/or PPA module 146, and/or data received from third party sources 106, for example.

Mapping service module 144 is generally configured to provide mapping services to clients devices, such as mobile device 104. For example, mapping service module 144 may receive position/location information from client devices (e.g., current locations of the client devices, and/or information representing addresses or other locations entered by users at the client devices, etc.), and in response provide the client devices with respective sets of map data to be rendered or otherwise displayed at the client devices. As another example, mapping service module 144 may receive requests for directions from client devices, and in response provide the client devices with respective sets of text and/or map-based directions to the desired destinations.

PPA module 146 is generally configured to perform various operations that enable map server 102 to identify routes commonly taken by users and the timing of those routes, identify convenient, low-price purchase points along (i.e., on or near) those routes, and notify client devices of those purchase points. In the example embodiment of FIG. 1, PPA module 146 includes an activity segmentation unit 150, a route determination unit 152, a provider identification unit 154, and a notification unit 156, all of which are described further below. In some implementations, PPA module 146 is entirely included within mapping service module 144, or portions of PPA module 146 (e.g., activity segmentation unit 150) are instead included within mapping service module 144. In still other implementations, server 102 is not a map server, and mapping service module 144 is omitted. For example, server 102 may be a server of a company that is dedicated to providing purchasing suggestions to customers.

In some implementations, mapping service module 144 and/or PPA module 146 may be (or may include) respective sets of one or more processors that execute software instructions stored in memory 142 (or elsewhere) to perform the functions described herein, or may share a set of one or more processors. In other implementations, mapping service module 144 and/or PPA module 146 may be components of software stored in memory 142 (or elsewhere) and executed by one or more processors (not shown in FIG. 1) of map server 102 to perform the functions described herein. In still other implementations, at least some functionality of mapping service module 144 and/or PPA module 146 may be provided by hardware processors (e.g., field-programmable gate arrays (FPGAs) and/or application-specific integrated circuits (ASICs)). In some implementations, map server 102 may include more, fewer and/or different modules or units than are shown in FIG. 1.

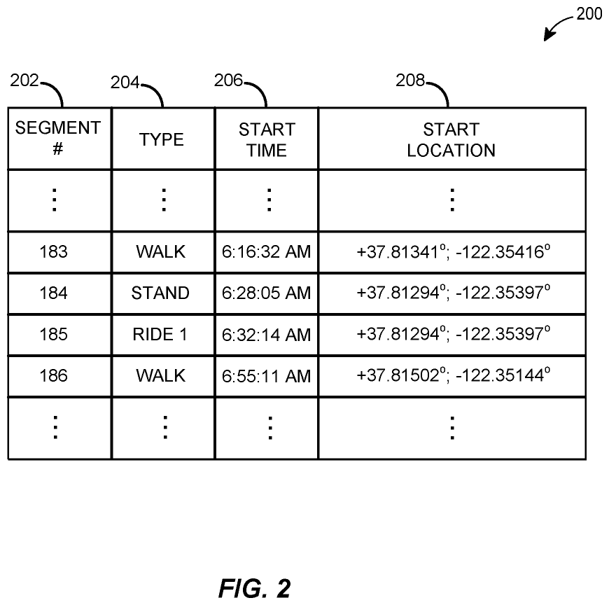

Generally, if the user has indicated that server 102 is authorized to collect and use his or her data, map server 102 may collect, from mobile device users, user data relating to movement (e.g., locations of the users' devices over time). Map server 102 may log the user data in a user database 160. User database 160 may be stored in a single memory, or may be distributed across multiple memories and/or locations. As just one example, the user data may include, for each of multiple devices/users, a series of precise locations (e.g., latitude and longitude coordinates) each with a corresponding time stamp representing the time at which the user/device was at that precise location. The user data may also store other information, including information determined by mapping service module 144 or PPA module 146. For example, user database 160 may store indicators of whether particular locations/times are associated with a particular mode of travel (e.g., walking, riding in a vehicle, etc.), as discussed further below in connection with FIG. 2.

Map server 102 is also communicatively coupled to a pricing database 162, which stores current pricing information of one or more goods and/or services, as received from third party sources 106. As the term is used herein, “current” prices/pricing may refer to real-time prices, or prices that were recently offered (e.g., within the last week, day, hour, etc.). Pricing database 162 may be stored in a single memory, or may be distributed across multiple memories and/or locations.

In operation, according to one example implementation, each of third party sources 106 provides current prices of a good or service (or multiple goods and/or services) to map server 102 via network 110 and network interface 140, and PPA module 146 stores the received prices (with identifiers of the respective providers of those prices) in pricing database 162. The good or service may be any good or service having a price that can fluctuate across time, location, and/or provider. For example, third party sources 106 may be computing systems of specific gas stations (or of companies associated with one or more gas stations). As another example, third party sources 106 may be computing systems of specific charging stations providing charges for electric vehicles (or associated companies). As another example, third party sources 106 may be computing systems of specific cafes (or associated companies). As yet another example, third party sources 106 may be computing systems of specific hotels (or associated companies). As still another example, third party sources 106 may be computing systems of specific car wash stations (or associated companies). Thus, the prices may be gas prices, electric vehicle charging prices, coffee prices, hotel stay prices, and so on.

Third party sources 106 may transmit current pricing to map server 102 via any suitable technology. In one implementation, for example, the computing systems may invoke an application programming interface (API) exposed by PPA module 146, or using a website hosted by map server 102 and a HTTP post operation, etc., to transmit the current prices to PPA module 146 via network 110 and network interface 140. In another example implementation, the current pricing is crowdsourced. For example, third party sources 106 may include smartphones and/or other mobile devices of different individuals, with each such device providing prices entered on the device by a respective individual (e.g., when visiting a particular gas station, coffee shop, etc.). Alternatively, third party sources 106 may include only a single server that collects such crowdsourced information, and provides that information to map server 102 via an API and/or website, etc. Current pricing may be provided on a fixed schedule, or on a random time basis (e.g., as individuals or companies decide to post new pricing data). In some implementations, PPA module 146 requests pricing data on an as-needed basis (e.g., after identifying a common/likely route for a particular user, and entities along that route, as discussed below).

As the user of mobile device 104 moves about over the course of multiple days, GPS unit 128 determines his or her locations and, if the user has indicated that server 102 is authorized to collect and use his or her data, mapping application 130 or another application sends the location data to map server 102 via user interface 124 and network 110. The location data may be time-stamped by mobile device 104 (e.g., by GPS unit 128 or mapping application 130), or by map server 102 (e.g., by mapping service module 144 or PPA module 146) as the locations are received. Mapping service module 144 or PPA module 146 may then store the locations and associated times in user database 160.

Activity segmentation unit 150 of PPA module 146 retrieves the user data that corresponds to mobile device 104 from user database 160, and processes the user data to identify the modes of travel of the user during different time segments. For example, activity segmentation unit 150 may determine that the user was walking during a particular time segment if the time/location data indicates that mobile device 104 was moving at less than 4 miles per hour during that time segment. As another example, activity segmentation unit 150 may determine that the user was standing during a particular time segment if the time/location data indicates that mobile device 104 was moving at less than 0.1 miles per hour (and/or moved a total of less than 20 feet, etc.), or not moving at all, during that time segment. As yet another example, activity segmentation unit 150 may determine that the user was driving in a vehicle during a particular time segment if the time/location data indicates that mobile device 104 was moving at, on average, more than 15 miles per hour (and/or had peak velocity of at least 25 miles per hour, etc.) during that time segment. When assigning a classifier/type to a particular time segment, activity segmentation unit 150 may select from among a pre-determined set of segment types (e.g., “standing,” “walking,” “running,” “biking,” “riding vehicle—automobile,” “riding vehicle—bus,” “riding vehicle—subway,” etc.). It is understood that the above classifications and criteria are merely illustrative, and that any other suitable criteria and/or categories/classifications may be used instead. Moreover, activity segmentation module 150 may also use various other factors (e.g., acceleration levels) to determine whether a vehicle was driven, or the type of vehicle. In some implementations, the functionality of activity segmentation module 150 is instead included in mobile device 104, which can then segment user data prior to sending that data to map server 102.

FIG. 2 illustrates an example collection 200 of segmented user data for mobile device 104 and/or the user of mobile device 104, which may be stored in user database 160. The data collection 200 may represent data output by activity segmentation unit 150 and logged in user database 160, for example. While many other arrangements and/or types of data may be used instead, the example data collection 200 includes, for each user, a number of segment identifiers 202, segment types 204, start times 206, and start locations 208. Each of segment types 204 may be set to the classification/type determined by activity segmentation unit 150, with start time 206 indicating the starting time for that segment and start location 208 indicating the starting location for that segment. In other implementations (e.g., if the segments are not necessarily all contiguous in time and/or may fail to cover all time periods), each segment may also be associated with additional information, such as an “end time,” “end location,” etc.

In the scenario corresponding to FIG. 2, data collection 200 corresponds to mobile device 104, at a time after activity segmentation unit 150 has determined that the user of mobile device 104 was walking, standing, riding, and then walking again during consecutive time segments. The segment type “Ride 1” may specifically indicate riding in an automobile, for example, whereas other designations (e.g., “Ride 2”) may indicate riding in a train, subway, etc.

While not shown in FIG. 2, data collection 200 may also include, for each segment identifier 202, a set of locations defining the route (if any) that was taken during that segment, and the times at which the user was at each of some or all locations on the route. Route determination unit 152 of PPA module 146 may identify all of the segments of a specific type that corresponds to ground vehicle travel, or to ground travel of a specific type (e.g., all “Ride 1” segments), and then analyzes those segments to identify routes that the user of mobile device 104 typically drives. To this end, route determination unit 152 may apply specific criteria to determine whether any two routes taken should be grouped/categorized as the same route, and specific criteria to determine whether, for any given route, the route is one that the user is likely to take again.

To group routes, for example, route determination unit 152 may view any two routes as the “same” route if no location along either one of the routes (as those locations are reflected in data collection 200) is more than a threshold distance away from the other one of the routes. Route determination unit 152 may also, or instead, apply other criteria, such as applying different distance thresholds for the starting point of the route, the end point of the route, and intermediate locations along the route, for example.

Once all routes for a user have been grouped appropriately (e.g., for all routes taken during the last week, month, year, or other suitable time period), route determination unit 152 may identify routes the user is likely to take again by analyzing the frequency of each route, and/or the number of times the user has traveled the route, etc. For example, route determination unit 152 may identify a route as one that the user is likely to take again if the user drives the route at least a threshold number of times in a given time period (e.g., at least once per week over the course of two months). In some implementations, route determination unit 152 seeks to identify routes that are not only likely to be driven again, but also have a predictable starting time (e.g., day of the week and/or time of day). For example, route determination unit 152 may determine that on at least 80% of (4 out of 5) weekday mornings, the user of mobile device 104 drives a particular route at 5:15 am (or within a certain time window centered at 5:15 am, such as a 30 minute window, etc.). In some implementations, route determination unit 152 separately categorizes routes that are repeatedly taken at different times, even if the route includes the exact same sequence of locations. For example, if a truck driver making local deliveries drives the same route at approximately 10:00 am and 2:30 pm each day, route determination unit 152 may classify each of those trips as a different route. Moreover, depending on the implementation, route determination unit 152 may or may not classify routes as being different routes if they cover the same locations, but are traveled in the opposite direction.

In some implementations, route determination unit 152 utilizes machine learning (e.g., a trained recurrent neural network) to predict, based on user data in database 160, routes that the user of mobile device 104 may take, and to predict the timing of such routes. Such an approach may improve upon the use of simpler algorithms by recognizing relatively hidden patterns in the user's driving habits (e.g., if a user does not travel a morning/afternoon commute on every last Friday of the month during the summer, etc.). The neural network(s) utilized by route determination unit 152 may accept as inputs historic location and time information, corresponding to driving in a vehicle (e.g., as indicated by segment type 204 in FIG. 2). In some implementations, the neural network(s) also accept other inputs, such as weather information, construction information, and/or other information, in order to make better-informed predictions.

Once route determination unit 152 has identified one or more likely routes for the user of mobile device 104, as well as a likely starting time for each of those routes, provider identification unit 154 may identify the providers of a particular good or service along each route. Provider identification unit 154 may accomplish this by querying mapping service module 144 to obtain POI information, for example. Alternatively, provider identification unit 154 may retrieve the price information from pricing database 162, if the current prices were already sent to map server 102 by the third party sources 106. Provider identification unit 154 may designate all entities along the route (e.g., all entities within a threshold distance of at least one location on the route) that provide the good or service of interest as “candidate” entities.

For each candidate entity that is on or near the route, provider identification unit 154 may determine whether the current price offered by that entity is sufficiently low to justify notifying the user. To this end, provider identification unit 154 may apply one or more criteria. For example, provider identification unit 154 may select only those candidate entities offering a price that is equal to or lower than all other providers of the same good or service along that route. As another example, provider identification unit 154 may select only those candidate entities offering a price that is lower than at least 75% of other providers of the same good or service along the route. As yet another example, provider identification unit 154 may select only those candidate entities offering a price that is lower than an average or median price of providers of the same good or service within a larger region (e.g., within the same zip code, state, country, etc.).

Notification unit 156 may determine a suitable time for sending notifications of the selected candidate entities (and/or the prices those entities offer, the entity locations, etc.) to the user. To do so, notification unit 156 may determine a suitable notification time based on the likely route starting time as determined by route determination unit 152. For example, notification unit 156 may designate a time that is 15 minutes before the likely route start time to be the notification time. Notification unit 156 may also generate the contents of the notification messages, and cause network interface 140 to send the messages to mobile device 104 at the designated time (e.g., each weekday at 6:15 am, or every Sunday afternoon at 3:30 pm, etc.).

Notifications may be sent to mobile devices such as mobile device 104 using any suitable technology. For example, a news aggregator may be installed on mobile device 104, and the user of mobile device 104 may subscribe to a Rich Site Summary (RSS) news feed with content that is sourced by notification unit 156. Alternatively, notification unit 156 may push messages to mobile device 104. Notifications may appear on a display screen of user interface 124 of mobile device 104, e.g., as banners, alerts, messages within websites visited by the user when mobile device 104 executes a mobile web browser application (e.g., a message on a personalized “home page” of the user), and so on, depending on the implementation.

In some implementations, notification unit 156 provides indications that account for additional factors. As noted above, for instance, mobile device 104 may couple to one or more vehicle units to obtain information such as gas level, charge level, and/or fuel efficiency. Mobile device 104 may provide that information to map server 102, on a periodic or other suitable basis, via user interface 124 and network 110. Additionally or alternatively, in some implementations, PPA module 146 may obtain vehicle information from another source. For example, PPA module 146 may obtain (e.g., via an Internet connection) specified fuel efficiency metrics for vehicles that match the vehicle type of the owner of mobile device 104.

Provider identification unit 154 may determine which number of providers to identify, or the distance between each such provider, etc., based on this additional information. For example, if PPA module 146 has learned that the vehicle of the user of mobile device 104 has only about three gallons left in the gas tank, and that the vehicle has a fuel efficiency of 20 miles per gallon, provider identification unit 154 may determine, for the predicted upcoming route of the user, the lowest-priced gas provider that is somewhere along the first 60 miles of the route (or along the first 54 miles, so as to provide a 10% safety cushion, etc.). Alternatively, PPA module 146 may have learned that, irrespective of the vehicle's specified miles per gallon, the user tends to drive in a manner that results in a fuel efficiency of only 16 miles per gallon. Accordingly, provider identification unit 154 may instead determine the lowest-priced gas provider that is somewhere along the first 48 miles of the route (or first 43.2 miles for a 10% cushion, etc.). It is understood that provider identification unit 154, and more generally PPA module 146, may also, or instead, utilize other types of information in order to provider “smarter” notifications, in vehicle fuel and/or other contexts.

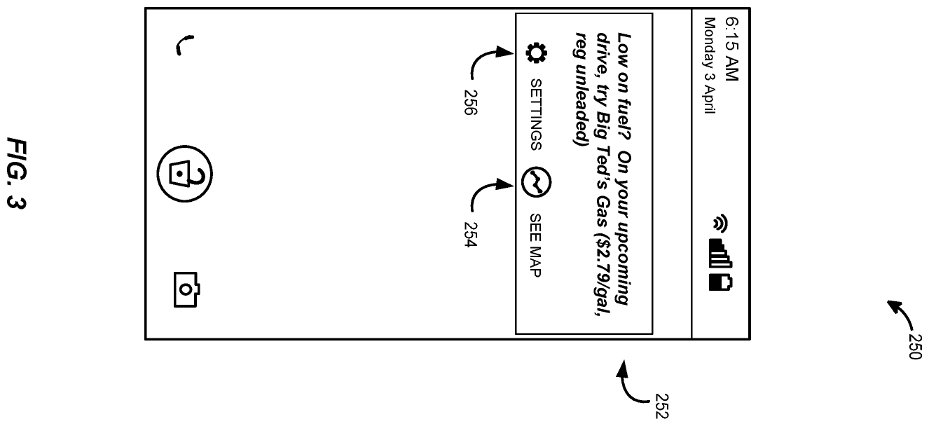

FIG. 3 depicts an example display screen 250 of mobile device 104, presenting an example notification 252. Notification 252 may be a message that notification unit 156 generated and sent to mobile device 104 for presentation to the user via a display screen of user interface 124, for example. Notification unit 156 may have determined the time of notification 252 (in this example, 6:15 am) based on information received from route determination unit 152. For example, in the scenario reflected in FIG. 3, route determination unit 152 may have informed notification unit 156 that the user typically (e.g., on most weekdays) begins driving a particular route at 6:30 am, and notification unit 156 may have applied a rule requiring that notifications be sent 15 minutes before predicted route starting times.

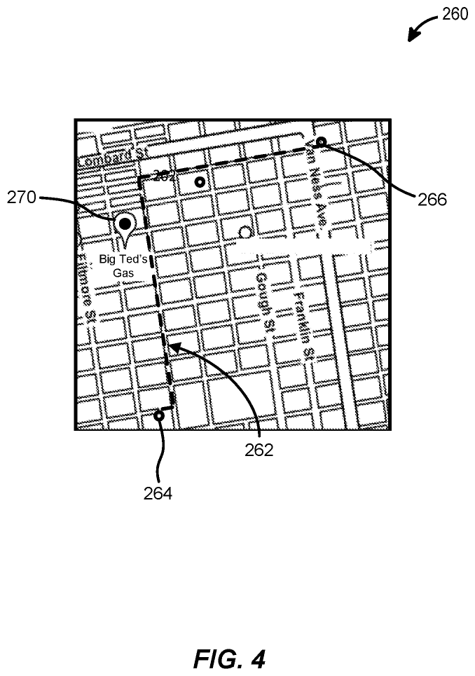

As seen in FIG. 3, the example notification 252 states: “Low on fuel? On your upcoming drive try Big Ted's Gas ($2.79/gal, reg unleaded).” Big Ted's Gas may be an entity identified by provider identification unit 154, and the price of $2.79 per gallon may be a price determined by provider identification unit 154. If the user knows where Big Ted's Gas is located, he or she may not need to take any further action. However, the user may also select (e.g., touch) an interactive control 254 to see the location of Big Ted's Gas on a map, along with the intended route. FIG. 4 depicts an example map 260 that may be displayed on the display screen of mobile device 104 in response to the user selecting interactive control 254. As seen in FIG. 4, map 260 depicts the user's predicted route 262 (from a starting point 264 to a destination 266), and a location 270 of the entity providing a relatively low gas price (here, Big Ted's Gas). In other implementations and/or scenarios, multiple locations of relatively low-priced gas stations may be depicted in map 260.

Returning now to FIG. 3, notification 252 also includes another interactive control 256 that enables the user to adjust notification settings. For example, user selection of interactive control 256 may cause a menu of notification options/settings to appear on display screen 250, such as an option to turn off all notifications from notification unit 156, or an option to turn off only those notifications relating to a particular predicted route, etc.

In alternative implementations, notification 252 is provided in a different format, and/or does not include the interactive controls 254 and/or 256. For example, notification 252 itself may show a map of the user's predicted route and the location(s) of the low-priced entity or entities along that route, without requiring that the user select any interactive controls.

### Example Method

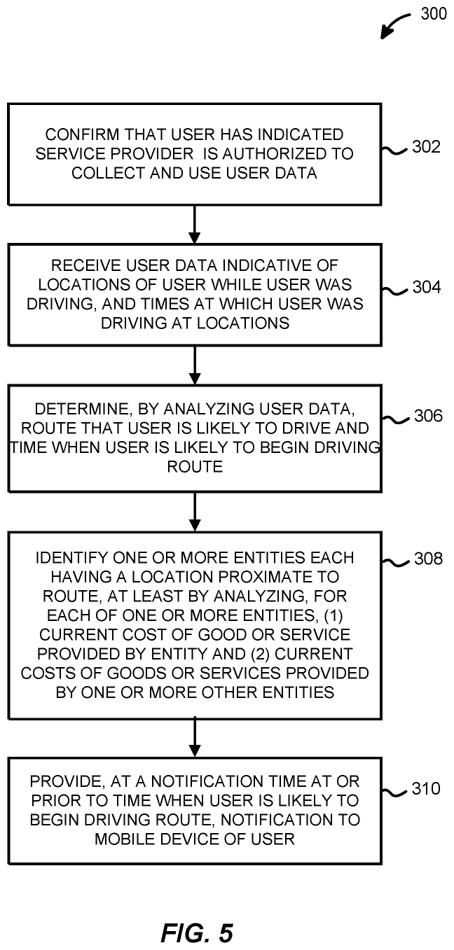

An example method 300 for providing advance notification of convenient purchase points is discussed next with reference to FIG. 5. The method 300 may be implemented as instructions stored on one or more computer-readable media and executed by one or more processors in one or more computing devices. For example, referring back to FIG. 1, the method 300 may be implemented by server 102.

At block 302, it is confirmed that the user has indicated that a provider of a service for providing advance notification of convenient purchase points is authorized to collect and use his or her data. If no such indication was made by the user, blocks 304 through 310, or blocks 306 through 310, may not occur.

At block 304, user data is received. The user data is indicative of locations of a user of a mobile device while he or she was driving a vehicle (e.g., an automobile or motorcycle), as well as the times at which the user was driving at those locations. In some implementations, the user data includes GPS locations, and times corresponding to those GPS locations.

At block 306, a route that the user is likely to drive, and a time when the user is likely to begin driving that route, are determined by analyzing the received user data. If the user data includes GPS data, for example, block 306 may include analyzing latitudes and longitudes in the GPS data, and the respective times, in order to reconstruct routes of the user. The frequency of driving each different route (or the number of times driving each route, etc.) may be used to determine how likely it is that a user will again drive the route (e.g., by applying frequency and/or other thresholds), and the times associated with the starting locations of the routes may be used to determine when the user is likely to begin driving those routes. In some implementations, the earliest of the starting times is selected as the likely start time for a route. In other implementations, the average or median starting time is selected, or another suitable calculation or algorithm is used. Block 306 may include executing the functions of route determination unit 152 (and possibly also activity segmentation unit 150) as described above in connection with FIG. 1, for example. Block 306 may be performed by one or more neural networks (e.g., a recurrent neural network), or using heuristic algorithms, for example.

At block 308, one or more entities, each having a location proximate to the determined route, are identified. Entities may be considered “proximate” to the route if they are within a threshold distance of one or more locations on the route, for example, or using one or more other suitable criteria (e.g., by ruling out entities at locations that require more than a threshold number of turns after leaving the route, etc.). Block 308 includes analyzing, for each such entity, a current price of a good or service provided by the entity, as well as current prices of goods or services provided by one or more other entities. For example, a current gas price of the entity may be compared to current gas prices offered by one or other entities that are in the same region, or along the same route, etc. As another example, the current gas price of the entity may be compared to an average or median price offered by one or other entities that are in the same region, or along the same route, etc. The price information for the various entities may be received from computing devices (e.g., servers) of the various entities, from crowdsourcing devices (e.g., smartphones of numerous users that visit the entities), from a server that consolidates information from crowdsourcing devices, and/or from any other suitable source(s).

At block 310, a notification is provided to the user's mobile device at a particular time that is at, or prior to (e.g., 5 minutes before, 15 minutes before, or some other predetermined amount of time before), the time determined at block 306. The notification indicates the entity or entities identified at block 308 (e.g., company names), and/or locations of the entity or entities (e.g., addresses, or depictions on a map along with the route, etc.). Thus, the user may view the notification, and possibly make plans regarding any short detours to be made (and whether to leave earlier than usual, etc.), before he or she begins driving (after which such actions could be a dangerous distraction). In some implementations, the timing of the notification is also dependent upon real-time user data. For example, the notification may be provided at a time that is within a threshold amount of time (e.g., 30 minutes) of the time when the user is likely to begin driving the route, but only if/when position data from the user's mobile device indicates that he or she is within a threshold distance of the starting location of the route. The notification may be provided via an RSS feed to which the user has subscribed, or using any other suitable technique.

### Other Considerations

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments (“embodiments” and “implementations” being used interchangeably herein) are described in the present disclosure as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described in the present disclosure.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described in the present disclosure. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described in the present disclosure may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to in the present disclosure may, in some example embodiments, comprise processor-implemented modules.

Similarly, the methods or routines described in the present disclosure may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, at least some of the operations may be performed by a group of computers (as examples of machines including processors), these operations being accessible via a network (e.g., the Internet) and via one or more appropriate interfaces (e.g., application program interfaces (APIs).)

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used in the present disclosure, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments in the present disclosure. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for providing advance notification of convenient purchase points to a user through the disclosed principles in the present disclosure. Thus, while particular embodiments and applications have been illustrated and described, it is to be understood that the disclosed embodiments are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method for providing advance notification of convenient purchase points, the method comprising:
receiving, by one or more processors, user data indicative of (i) a plurality of locations of a user while the user was driving and (ii) times at which the user was driving at the plurality of locations;
determining, by one or more processors analyzing the user data, a route that the user is likely to drive and a time when the user is likely to begin driving the route;
identifying, by one or more processors, one or more entities each having a location proximate to the route, at least by analyzing, for each of the one or more entities, (i) a current price of a good or service provided by the entity and (ii) current prices of goods or services provided by one or more other entities; and
providing, at a notification time that is at or prior to the time when the user is likely to begin driving the route, a notification to a mobile device of the user, the notification indicating one or both of (i) the one or more entities and (ii) locations of the one or more entities.

2. The method of claim 1, wherein receiving user data includes receiving, from the mobile device, a plurality of GPS locations and a plurality of times each corresponding to a different one of the GPS locations.

3. The method of claim 2, wherein determining the route that the user is likely to drive includes:
determining, based on the plurality of GPS locations, a plurality of routes traveled by the user; and
identifying, among the plurality of routes, the route that the user is likely to drive.

4. The method of claim 3, wherein identifying the route that the user is likely to drive includes determining that the route was driven at least a threshold number of times or with at least a threshold frequency.

5. The method of claim 3, wherein determining a time when the user is likely to begin driving the route includes:
identifying, among the plurality of times each corresponding to a different one of the GPS locations, a plurality of start times each corresponding to a different time when the user started driving the route; and
determining the time when the user is likely to begin driving the route based on the plurality of start times.

6. The method of claim 5, wherein determining the time when the user is likely to begin driving the route includes either:
using an earliest time of the plurality of start times as the time when the user is likely to begin driving the route; or
using an average or median time of the plurality of start times as the time when the user is likely to begin driving the route.

7. The method of claim 1, wherein identifying one or more entities each having a location proximate to the route includes determining which entities, of a predetermined type, are within a threshold distance of one or more locations on the route.

8. The method of claim 1, wherein identifying one or more entities each having a location proximate to the route includes comparing the current price of the good or service provided by the entity to the current prices of the goods or services provided by the one or more other entities.

9. The method of claim 1, wherein identifying one or more entities each having a location proximate to the route includes comparing the current price of the good or service provided by the entity to an average or median price of the goods or services provided by the one or more other entities.

10. The method of claim 1, wherein providing, at the notification time, the notification to the mobile device of the user includes providing the notification to the mobile device a predetermined amount of time before the time when the user is likely to begin driving the route.

11. The method of claim 1, wherein providing, at the notification time, the notification to the mobile device of the user includes providing the notification to the mobile device at a time (i) within a threshold amount of time of the time when the user is likely to begin driving the route, and (ii) when the user is within a threshold distance of a starting location of the route.

12. The method of claim 1, wherein providing, at the notification time, the notification to the mobile device of the user includes providing the notification to the mobile device via an RSS feed to which the user has subscribed.

13. A computing system comprising:
one or more database memories collectively storing a database;
one or more processors; and
one or more memories storing instructions that, when executed by the one or more processors, cause the computing system to
receive user data indicative of (i) a plurality of locations of a user while the user was driving and (ii) times at which the user was driving at the plurality of locations,
store the received user data in the database,
determine, by analyzing the user data stored in the database, a route that the user is likely to drive and a time when the user is likely to begin driving the route,
identify one or more entities each having a location proximate to the route, at least in part by analyzing, for each of the one or more entities, (i) a current price of a good or service provided by the entity and (ii) current prices of goods or services provided by one or more other entities, and
provide, at a notification time that is at or prior to the time when the user is likely to begin driving the route, a notification to a mobile device of the user, the notification indicating one or both of (i) the one or more entities and (ii) locations of the one or more entities.

14. The computing system of claim 13, wherein:
the user data includes a plurality of GPS locations of the mobile device and a plurality of times each corresponding to a different one of the GPS locations; and
the instructions cause the computing system to determine the route that the user is likely to drive at least by
determining, based on the plurality of GPS locations, a plurality of routes traveled by the user, and
identifying, among the plurality of routes, the route that the user is likely to drive.

15. The computing system of claim 14, wherein the instructions cause the computing system to determine the route that the user is likely to drive by further:
determining that the route was driven at least a threshold number of times or with at least a threshold frequency;
identifying, among the plurality of times each corresponding to a different one of the GPS locations, a plurality of start times each corresponding to a different time when the user started driving the route; and
determining the time when the user is likely to begin driving the route based on the plurality of start times.

16. The computing system of claim 13, wherein the instructions cause the computing system to identify the one or more entities each having a location proximate to the route at least by determining which entities, of a predetermined type, are within a threshold distance of one or more locations on the route.

17. The computing system of claim 13, wherein the notification time is a time (i) within a threshold amount of time of the time when the user is likely to begin driving the route, and (ii) when the user is within a threshold distance of a starting location of the route.

18. One or more non-transitory, computer-readable media collectively storing instructions that, when executed by one or more processors, cause the one or more processors to:
receive user data indicative of (i) a plurality of locations of a user while the user was driving and (ii) times at which the user was driving at the plurality of locations;
determine, by analyzing the received user data, a route that the user is likely to drive and a time when the user is likely to begin driving the route;
identify one or more entities each having a location proximate to the route, at least in part by analyzing, for each of the one or more entities, (i) a current price of a good or service provided by the entity and (ii) current prices of goods or services provided by one or more other entities; and
provide, at a notification time that is at or prior to the time when the user is likely to begin driving the route, a notification to a mobile device of the user, the notification indicating one or both of (i) the one or more entities and (ii) locations of the one or more entities.

19. The one or more non-transitory, computer-readable media of claim 18, wherein:
the user data includes a plurality of GPS locations of the mobile device and a plurality of times each corresponding to a different one of the GPS locations; and
the instructions cause the one or more processors to determine the route that the user is likely to drive at least by
determining, based on the plurality of GPS locations, a plurality of routes traveled by the user, and
identifying, among the plurality of routes, the route that the user is likely to drive.

20. The one or more non-transitory, computer-readable media of claim 19, wherein the instructions cause the one or more processors to determine the route that the user is likely to drive by further:
determining that the route was driven at least a threshold number of times or with at least a threshold frequency;
identifying, among the plurality of times each corresponding to a different one of the GPS locations, a plurality of start times each corresponding to a different time when the user started driving the route; and
determining the time when the user is likely to begin driving the route based on the plurality of start times.
